(19) United States
(12) Patent Application Publication
(10) Pub. No.: US 2009/0048003 A1
(43) Pub. Date: Feb. 19, 2009

(54) CONTACTLESS POWER SUPPLY SYSTEM AND METHOD THEREOF

(76) Inventors: Yu-Shiang Lu, Chiayi County (TW); Hsi-Chang Wu, Yun-Lin County (TW); Pei-Wen Sun, Hsinchu County (TW); Richard Lin, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/936,050

(22) Filed: Nov. 6, 2007

(30) Foreign Application Priority Data
Aug. 13, 2007 (TW) 096129858

(51) Int. Cl. H04B 1/40; G06F 1/26; H02J 17/00; H02J 7/00

(52) U.S. Cl. 455/573; 307/149; 320/137; 713/300

(57) ABSTRACT

A contactless power supply system includes a power supply device having a first sensor module configured for outputting a first wireless signal, and a plurality of application devices for receiving the first wireless signal simultaneously, where each of the plurality of application devices includes a second sensor module for receiving the first wireless signal and transforming the first wireless signal into a corresponding induced power. A method for contactless power supply includes receiving a wireless signal and transforming the wireless signal into a corresponding induced power, and charging a battery module according to the corresponding induced power.

### BACKGROUND OF THE INVENTION

1. Field of the Invention

The present invention relates to a power supply approach, and more particularly, to a contactless power supply system and method thereof.

2. Description of the Prior Art

Please refer to FIG. 1. FIG. 1 is a block diagram of a portable handheld device according to prior art. The prior art portable handheld device—for example, a mobile phone or a personal digital assistant (PDA)—utilizes a contact charging method shown in FIG. 1 to perform charging, i.e., it needs a plug 104 for connecting between a charger 100 and an uncharged device 102 to charge a battery of the uncharged device 102 via external power. In this traditional charge approach, it causes inconvenience for users due to insertion and extraction of the plug 104 between the charger 100 and the uncharged device 102, and there is damage of the plug 104 or an imperfect connection between the charger 100 and the uncharged device 102 due to repetitive insertions and extractions. Additionally, for different products in the prior art approach, the different products have different plug types of charger. Therefore, products must be designed with different plugs corresponding to various chargers, but for users, this is very inconvenient when using many products and many chargers.

In addition, the prior art charger 100 usually charges one uncharged device 102 at the same time. This situation has limitations of one-to-one use, and consequently, the prior art charger 100 does not charge many uncharged device 102 at the same time. When a user carries many uncharged devices charged through the charge approach shown in FIG. 1, then the user needs to carry many corresponding chargers to charge the many uncharged devices. As a result, the prior art charger 100 seriously decreases convenience of use, and adds to a user's burden.

### SUMMARY OF THE INVENTION

It is therefore one of the objectives of the claimed invention to provide a contactless power supply system and method thereof, to solve the above-mentioned problems and enhance image quality.

According to one embodiment of the claimed invention, a contactless power supply system is disclosed. The contactless power supply comprises a power supply device having a first sensor module configured for outputting a first wireless signal, and a plurality of application devices for receiving the first wireless signal simultaneously. Each application device of the plurality of application devices comprises a second sensor module for receiving the first wireless signal and transforming the first wireless signal into a corresponding induced power.

According to yet another embodiment of the present invention, an application device with a contactless power supply is disclosed. The application device comprises a sensor module for receiving a wireless signal and transforming the wireless signal into a corresponding induced power, a battery module, and a charge module. The charge module is coupled to the sensor module and the battery module, and is for charging the battery module according to the corresponding induced power.

According to yet another embodiment of the present invention, a method for contactless power supply is further disclosed. The method comprises outputting a wireless signal to a plurality of application devices simultaneously and transforming the received wireless signal into an induced power corresponding to the each of the plurality of the application devices.

According to yet another embodiment of the present invention, a method for contactless power supply is further disclosed. The method comprises receiving a wireless signal and transforming the wireless signal into a corresponding induced power, and charging a battery module according to the corresponding induced power.

In conclusion, users may utilize a charger to charge the plurality of uncharged devices for one-to-many via the contactless power supply system and method thereof provided by the present invention. As a result, it enhances the convenience of using the charger. The method for contactless power supply not only avoids the limitation of various plugs due to product design, however, but also prevents problems of incompatibility for plugs of the chargers. As a result, the contactless power supply system and method thereof provided by the present invention may integrate various types of products into a set of the power supply system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a prior art portable handheld device.

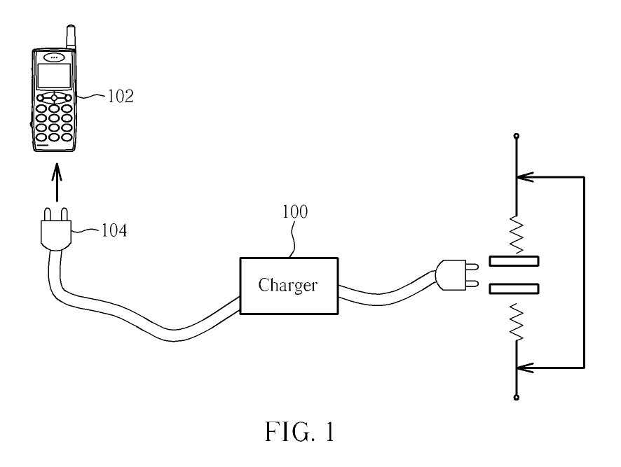

FIG. 2 is a function block diagram illustrating a contactless power supply system according to an embodiment of the present invention.

FIG. 3 is a diagram illustrating an application device with contactless power supply function according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

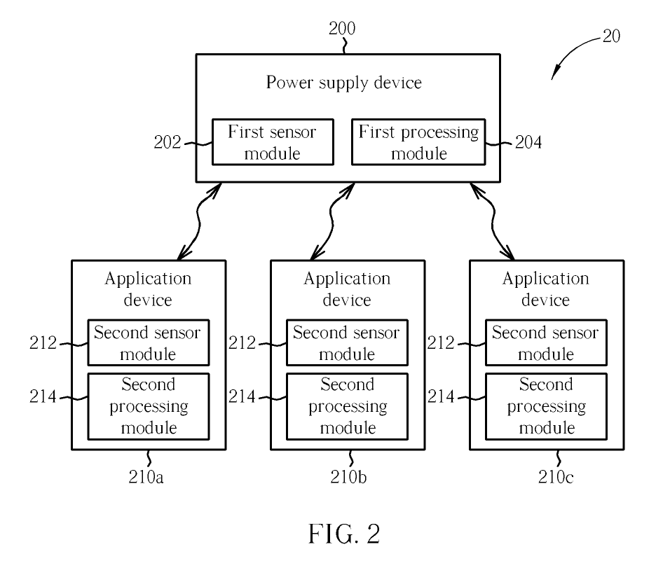

Please refer to FIG. 2. FIG. 2 is function block diagram illustrating a contactless power supply system 20 according to an embodiment of the present invention. As shown in FIG. 2, the contactless power supply system 20 comprises a power supply device 200 and a plurality of application devices 210a, 210b and 210c in the present invention, wherein the power supply device 200 further comprises a first sensor module 202 configured for outputting a first wireless signal for communicating with the plurality of application devices 210a, 210b and 210c. The first processing module 203 is for generating a first message (for example, control commands, user data or other types of information), and in a predetermined operation (for example, identity identification or data exchange), the first processing module 203 further generates the first wireless signal according to the first message. The aforementioned predetermined operation will be detailed in the following description. In addition, in FIG. 2, the application devices 210a, 210b and 210c are utilized for receiving the aforementioned first wireless signal simultaneously, and each of the application devices 210a, 210b and 210c further comprises a second sensor module 212 and a second processing module 214. When the application devices 210a, 210b and 210c receive the first wireless signal sent by the power supply device 200, the second sensor module 212 is utilized for transforming the received first wireless signal into a corresponding induced power (for example, through the electromagnetic induction theorem). In an embodiment of the present invention, the induced power is utilized for performing the charge operation accordingly, such that it may achieve the objectives of utilizing a single power supply device 200 to charge the application devices 210a, 210b and 210c simultaneously. It should be noted that only three application devices 210a, 210b and 210c are shown in FIG. 2 for brevity, but the contactless power supply system 20 disclosed by the present invention is not limited by the number of the application devices.

It should be noted that, as shown in FIG. 2, the exemplary application devices 210a, 210b and 210c are handheld devices. They can be, for example and without limitation, a mobile phone, a personal digital assistant (PDA), a multimedia player, a notebook computer, or a handheld entertainment apparatus such as a Sony PlayStation Portable (PSP) or Nintendo DS (NDS). In addition, in an embodiment of the present invention, the power supply device 200 receives an external power (for example, mains power), and then the first sensor module 202 generates the first wireless signal directly according to the external mains power and simultaneously outputs the first wireless signal into the plurality of application devices 210a, 210b and 210c inside of a receiving range. The first wireless signal can be, without limitation, an electromagnetic wave signal, wherein the electromagnetic wave signal may be in the form of a radio frequency (RF) signal, an infrared wave signal, a microwave signal or a Bluetooth signal. When the application devices 210a, 210b and 210c are inside of the receiving range of the first wireless signal, the application devices 210a, 210b and 210c may receive the first wireless signal, and simultaneously transform the received first wireless signal into an induced power corresponding to each application device, according to the design of the second sensor module 212 used to perform the following charging operations. Please note that this is for illustrative purposes only and is not meant to be a limitation of the present invention, i.e. the generated induced power may have other uses.

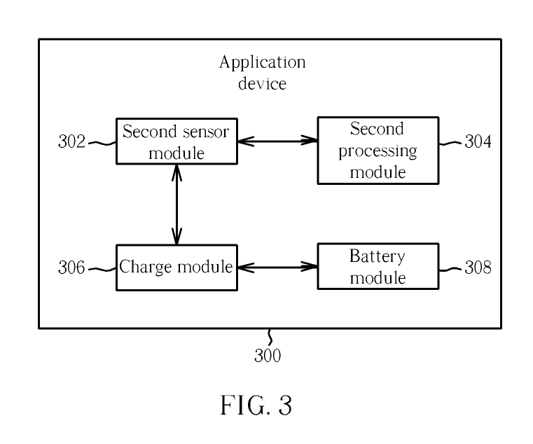

Please refer to FIG. 3. FIG. 3 is a diagram illustrating an application device 200 with a contactless power supply function according to an embodiment of the present invention. As shown in FIG. 3, the application device 300 is a detailed architecture diagram of the application devices 210a, 210b and 210c shown in FIG. 2. Please note that, without influencing the art disclosed by the present invention, FIG. 3 shows only elements relating to the contactless power supply function. The application device 300 comprises a second sensor module 302, a second processing module 304, a charge module 306 and a battery module 308. The second sensor module 302 is the second sensor module 212 shown in FIG. 2, for receiving the first wireless signal and transforming the first wireless signal into a corresponding induced power. The second processing module 304 is the second processing module 214 shown in FIG. 2, for retrieving the first message transmitted by the first wireless signal received by the second sensor module 302. The charge module 306, coupled to the second sensor module 302 and the battery module 308, is for charging the battery module 308 according to the corresponding induced power. The battery module 308 is a main power source of the application device 300. In brief, when the application device 300 is located within the receiving range of the wireless signal sent by the power supply device 200, then the application device 300 (for example, application devices 210a, 210b and 210c), takes the induced power generated by the second sensor module 302 as the external power needed for charging, and the induced power performs charging with the battery module 308 through the charge module 306.

It should be noted that the first processing module 204 of the power supply device 200 shown in FIG. 2 performs signal processing. In addition, the second processing module 214 of each of the application devices 210a, 210b and 210c shown in FIG. 2 also performs signal processing functions. As a result, the second processing module 214 similarly controls the second sensor module 212 to transmit messages wirelessly. In the other words, the contactless power supply system 20 disclosed by the present invention not only performs the functions of power transmission, but also performs other operations. Accordingly, some examples further illustrating this detailed description follow.

In an operation example of the present invention, the contactless power supply system 20 further performs data exchange between the power supply device 200 and the application devices 210a, 210b and 210c except for the contactless power supply. First, the first processing module 204 controls the first sensor module 202 to send a first message (for example, multimedia or other type of data), via the first wireless signal. Then the application devices 210a, 210b and 210c receive the first wireless signal carrying the first message via the second sensor module 212. At present, the second sensor module 212 generates an induced power according to the first wireless signal, and the second processing module 214 retrieves the first message from the first wireless signal received by the second sensor module 212. Subsequently, for the application devices 210a, 210b and 210c, the second processing module 214 further generates a second message (again using multimedia or some other type of data as an example), and controls the second sensor module 212 to send the second message via a second wireless signal. The power supply device 200 receives the second wireless signal carrying with the second message via the first sensor module 202. And then, the first processing module 204 retrieves the second message from the second wireless signal received by the first sensor module 202. Please note that the second wireless signal, without limitation, may be in the form of a radio frequency (RF) signal, an infrared wave signal, a microwave signal, or a Bluetooth signal.

It should be noted that, in this alternative design of the present invention, when the power supply device 200 is a multimedia player (i.e. the power supply device 200 is implemented in a device that plays multimedia data) and the second message is a multimedia data (an audio stream or video stream, for example), then the second message is displayed by the first processing module 202 of the power supply device 200. In another alternative design of the present invention, the application devices 210a, 210b and 210c are multimedia players and the first message is multimedia data (audio streams or video streams), where the first message is displayed by the second processing module 214. Please note that these aforementioned alternative designs all fall within the scope of the present invention.

In another operation example of the present invention, the contactless power supply system 20 further performs device identification between the power supply device 200 and the application devices 210a, 210b and 210c, except for the contactless power supply. In this embodiment, a first message generated by the first processing module 204 is an identification command, and the processing module 204 controls the first sensor module 202 to send the first message (identification) via a first wireless signal. Then the application devices 210a, 210b and 210c receive the first wireless signal carrying with the first message (identification request) via the second sensor module 212. At this time, the second sensor module 212 generates an induced power according to the first wireless signal, and the second processing module 214 retrieves the first message from the first wireless signal received by the second sensor module 212. For application devices 210a, 210b and 210c, the second processing module 214 controls the second sensor module 212 to send a second message via a second wireless signal according to the received identification command. For example, the second message contains identification information corresponding to the application devices 210a, 210b and 210c, and the identification information may comprise (for instance and without limitation) power information and an identification code. The power supply device 200 receives the second wireless signal carrying the second message (identification information) through the first sensor module 202. Lastly, the first processing module 204 retrieves the second message from the second wireless signal received by the first sensor module 202, obtains information on which of the application devices support the contactless power supply function, or which of the application devices 210a, 210b and 210c within the receiving range of the first processing module 204 need to be charged, and performs applicable controls for the application devices.

For example, an application of the above-mentioned identification operation is utilized to perform contactless power supply control for the application devices 210a, 210b and 210c, i.e. through a second message (comprising power information and an identification code) returned by the application devices 210a, 210b and 210c. The power supply device 200 may obtain which battery module of the application device is currently in a low power status (for example, the battery module 308 shown in FIG. 3). If the battery module of the application module 210a is currently low in power but the battery modules of the other application devices 210b and 210c still have sufficient charge, then the first processing module 204 generates a specific control command according to the identification code of the application device 210a to start a charge module of the application device 210a (for example, the battery module 306 shown in FIG. 3). The first processing module 204 then controls the first sensor module 202 to send the specific control command via a first wireless signal. Because the specific control command is aimed at the application device 210a, the specific control command comprises the identification code of the application device 210a accordingly. Although the application devices 210a, 210b and 210c all receive the specific control command, however, only the application device 210a starts the battery module for charging the battery module. As a result, the contactless power supply system 20 of the present invention achieves the objectives of controlling contactless charge operations of the application devices 210a, 210b and 210c. Please note that the aforementioned embodiments are for illustrative purposes only and are not meant to be limitations of the present invention; other applications of the identification operation fall within the scope of the present invention.

In the present invention, any combination (without limitation) of the charge operation, data exchange operation and identification operation are synchronously performed between the power supply device 200 and each of the application devices 210a, 210b and 210c. Furthermore, without limitation, operations of charge, data exchange and identification are asynchronously performed between the power supply device 200 and each of the application devices 210a, 210b and 210c. It should be noted that the operations mentioned above are for illustrative purposes only and are not meant to be limitations of the present invention.

Those skilled in the art will readily observe that numerous modifications and alterations of the device and method may be made while retaining the teachings of the invention.

What is claimed is:

1. A contactless power supply system, comprising;
a power supply device having a first sensor module configured for outputting a first wireless signal; and
a plurality of application devices, for receiving the first wireless signal simultaneously, wherein each application device of the plurality of application devices comprises a second sensor module, for receiving the first wireless signal and transforming the first wireless signal into a corresponding induced power.

2. The contactless power supply system of claim 1, wherein the each application device is a handheld device.

3. The contactless power supply system of claim 2, wherein the handheld device is a multimedia player, a mobile phone, a handheld entertainment apparatus, a notebook computer or a personal digital assistant (PDA).

4. The contactless power supply system of claim 1, wherein the power supply device further communicates with the plurality of application devices through the first wireless signal.

5. The contactless power supply system of claim 4, wherein the power supply device further comprises a first processing module, for generating a first message; the first sensor module generates the first wireless signal according to the first message; and the each application device further comprises a second processing module, for retrieving the first message transmitted by the first wireless signal received by the second sensor module.

6. The contactless power supply system of claim 5, wherein the each application device further communicates with the power supply device through a second wireless signal; the second processing module further generates a second message; the second sensor module generates the second wireless signal according to the second message; and the first processing module further retrieves the second message transmitted by the second wireless signal received by the first sensor module.

7. The contactless power supply system of claim 6, wherein the each application device further comprises a charge module and a battery module; the charge module charges the battery module according to the corresponding induced power; the first message is an identification command; the second message is an identification information of the each application device; and the first processing module further outputs a control command via the first processing module according to the identification information of the each application device into the application device to control whether the battery module of the application device is started.

8. An application device with contactless power supply, comprising:
a sensor module, for receiving a wireless signal and transforming the wireless signal into a corresponding induced power;
a battery module; and
a charge module, coupled to the sensor module and the battery module, for charging the battery module according to the corresponding induced power.

9. The application device of claim 8, wherein the application device is a handheld device.

10. The application device of claim 9, wherein the handheld device is a multimedia player, a mobile phone, a handheld entertainment apparatus, a notebook computer or a personal digital assistant (PDA).

11. A method for contactless power supply, comprising:
outputting a wireless signal to a plurality of application devices simultaneously; and
transforming the received wireless signal into an induced power corresponding to the each application device of the plurality of the application devices.

12. A method for contactless power supply, comprising:
receiving a wireless signal and transforming the wireless signal into a corresponding induced power; and
charging a battery module according to the corresponding induced power.
